(19) United States
(12) Patent Application Publication
(10) Pub. No.: US 2008/0217961 A1
(43) Pub. Date: Sep. 11, 2008

(54) Fiber reinforced polypropylene composite front end modules

(76) Inventors: Arnold Lustiger, Westfield, NJ (US); Jeffrey Valentage, Katy, TX (US)

Correspondence Address: ExxonMobil Research & Engineering Company, P.O. Box 900, 1545 Route 22 East, Annandale, NJ, 08801-0900, US

(21) Appl. No.: 12/074,594

(22) Filed: Mar. 5, 2008

Related U.S. Application Data
(60) Provisional application No. 60/905,263, filed on Mar. 6, 2007.

(51) Int. Cl. B60R 27/00; B21D 53/88

(52) U.S. Cl. 296/193.09; 29/897.2

(57) ABSTRACT

A fiber reinforced polypropylene composite front end module. The front end module includes a radiator mounting frame molded from a composition comprising at least 30 wt % polypropylene based resin, from 10 to 60 wt % organic fiber, from 0 to 40 wt % inorganic filler, and from 0 to 0.1 wt % lubricant, based on the total weight of the composition, the radiator mounting frame having at least a first side and a second side. A process for producing a front end module is also provided. The process includes the step of injection molding a composition to form the front end module, the front end module having a radiator mounting frame having at least a first side and a second side, wherein the composition comprises at least 30 wt % polypropylene, from 10 to 60 wt % organic fiber, from 0 to 40 wt % inorganic filler, and from 0 to 0.1 wt % lubricant, based on the total weight of the composition.

### CROSS-REFERENCE TO RELATED APPLICATIONS

This application claims the benefit of U.S. Provisional Application 60/905,263 filed Mar. 6, 2007, herein incorporated by reference in its entirety and is a Continuation-in-Part of U.S. Provisional Application 60/681,609 filed on May 17, 2005, also herein incorporated by reference in its entirety.

### FIELD

The present disclosure is directed generally to front end modules and the like produced from fiber reinforced polypropylene compositions and to processes for making such front end modules.

### BACKGROUND

In recent years, efforts have been made to improve the quality of vehicle construction and reduce the cost of manufacturing and operating the vehicle. Many of the components of the front end of a vehicle have been modularized into a single unit or front end module that can be attached to the vehicle frame. In other words, the front end module is provided with a frame with various front end components such as the radiator and headlamps coupled thereto. Thus, instead of individually installing the various front end components to the vehicle body, the various front end components are installed on a frame structure that is installed on the front end of the vehicle as a single unit. By using a front end module, the time required to assemble the front end of the vehicle has been drastically reduced.

In the molding of automobile parts, injection molding and injection/compression molding processes have been employed using a variety of materials. Attempts are underway in the automotive industry to produce an ever larger number of molded plastic parts. As is widely appreciated, plastic parts have the advantage of light weight, corrosion resistance and lower cost.

Steel is the current material of choice in the manufacturing of front end modules. However steel is a very heavy material due to its high specific gravity. Steel front end modules are manufactured using several steel stampings, welded together, and painted/coated to form the final module. This results in a very complex multi-step manufacturing process that requires significant resources to produce the final component.

Another type of front end module is formed as a hybrid of steel and a thermoplastic material. This type of module is produced by taking select pieces of stamped steel and inserting the pieces into an injection mold. A thermoplastic is then injection molded to form the front end module with the steel being encapsulated and/or surrounded by the thermoplastic. As may be appreciated, the steel adds needed strength in key areas. This type of module does help reduce weight by replacing the steel with thermoplastic, but complicates the injection molding process, requiring an injection mold that is very complex. In this type of module, engineered thermoplastics (ETP's) are used due to there inherent adhesion to other materials, although ETP's are much more expensive than polyolefin-based materials.

Still another type of front end module is formed by injection molding long glass fiber polypropylene (LGFPP). However, the use of LGFPP causes several issues in the manufacturing of front end modules. LGFPP tends to suffer from large differences in fiber distribution and shrinkage. This causes poor dimensional stability and warped parts. Also, due to natural fiber breakage from the injection molding process, material physical properties are significantly reduced. The use of glass fiber also causes severe wear to both the injection molding machine and mold.

Polyolefins have limited use in engineering applications due to the tradeoff between toughness and stiffness. For example, polyethylene is widely regarded as being relatively tough, but low in stiffness. Polypropylene generally displays the opposite trend, i.e., is relatively stiff, but low in toughness.

Several well known polypropylene compositions have been introduced that address toughness. For example, it is known to increase the toughness of polypropylene by adding rubber particles, either in-reactor resulting in impact copolymers, or through post-reactor blending. However, while toughness is improved, the stiffness is considerably reduced using this approach.

Glass reinforced polypropylene compositions have been introduced to improve stiffness. However, as mentioned above, the glass fibers have a tendency to break in typical injection molding equipment, resulting in reduced toughness and stiffness. In addition, glass reinforced products have a tendency to warp after injection molding.

Another known method of improving the physical properties of polyolefins is through the use of organic fiber reinforcement. For example, EP Patent Application 0397881, the entire disclosure of which is hereby incorporated herein by reference, proposes a composition produced by melt-mixing 100 parts by weight of a polypropylene resin and 10 to 100 parts by weight of polyester fibers having a fiber diameter of 1 to 10 deniers, a fiber length of 0.5 to 50 mm and a fiber strength of 5 to 13 g/d, and then molding the resulting mixture. Also, U.S. Pat. No. 3,639,424 to Gray, Jr. et al., the entire disclosure of which is hereby incorporated herein by reference, proposes a composition including a polymer, such as polypropylene, and uniformly dispersed therein at least about 10% by weight of the composition staple length fiber, the fiber being of man-made polymers, such as poly(ethylene terephthalate) (PET) or poly(1,4-cyclohexylenedimethylene terephthalate).

Fiber reinforced polypropylene compositions are also proposed in PCT Publication WO 02/053629, the entire disclosure of which is hereby incorporated herein by reference. More specifically, WO 02/053629 proposes a polymeric compound, comprising a thermoplastic matrix having a high flow during melt processing and polymeric fibers having lengths of from 0.1 mm to 50 mm. The polymeric compound comprises between 0.5 wt % and 10 wt % of a lubricant.

Various modifications to organic fiber reinforced polypropylene compositions are also known. For example, polyolefins modified with maleic anhydride or acrylic acid have been used as the matrix component to improve the interface strength between the synthetic organic fiber and the polyolefin, which was thought to enhance the mechanical properties of the molded product made therefrom.

Other background references include PCT Publication WO90/05164; EP Patent Application 0669372; U.S. Pat. No. 6,395,342 to Kadowaki et al.; EP Patent Application 1075918; U.S. Pat. No. 5,145,891 to Yasukawa et al., U.S. Pat. No. 5,145,892 to Yasukawa et al.; and EP Patent 0232522, the entire disclosures of which are hereby incorporated herein by reference.

U.S. Pat. No. 3,304,282 to Cadus et al. proposes a process for the production of glass fiber reinforced high molecular weight thermoplastics in which the plastic resin is supplied to an extruder or continuous kneader, endless glass fibers are introduced into the melt and broken up therein, and the mixture is homogenized and discharged through a die. The glass fibers are supplied in the form of endless rovings to an injection or degassing port downstream of the feed hopper of the extruder.

U.S. Pat. No. 5,401,154 to Sargent proposes an apparatus for making a fiber reinforced thermoplastic material and forming parts therefrom. The apparatus includes an extruder having a first material inlet, a second material inlet positioned downstream of the first material inlet, and an outlet. A thermoplastic resin material is supplied at the first material inlet and a first fiber reinforcing material is supplied at the second material inlet of the compounding extruder, which discharges a molten random fiber reinforced thermoplastic material at the extruder outlet. The fiber reinforcing material may include a bundle of continuous fibers formed from a plurality of monofilament fibers. Fiber types disclosed include glass, carbon, graphite and Kevlar.

U.S. Pat. No. 5,595,696 to Schlarb et al. proposes a fiber composite plastic and a process for the preparation thereof and more particularly to a composite material comprising continuous fibers and a plastic matrix. The fiber types include glass, carbon and natural fibers, and can be fed to the extruder in the form of chopped or continuous fibers. The continuous fiber is fed to the extruder downstream of the resin feed hopper.

U.S. Pat. No. 6,395,342 to Kadowaki et al. proposes an impregnation process for preparing pellets of a synthetic organic fiber reinforced polyolefin. The process comprises the steps of heating a polyolefin at the temperature which is higher than the melting point thereof by 40° C. or more to lower than the melting point of a synthetic organic fiber to form a molten polyolefin, passing a reinforcing fiber comprising the synthetic organic fiber continuously through the molten polyolefin within six seconds to form a polyolefin impregnated fiber, and cutting the polyolefin impregnated fiber into the pellets. Organic fiber types include polyethylene terephthalate, polybutylene terephthalate, polyamide 6, and polyamide 66.

U.S. Pat. No. 6,419,864 to Scheuring et al. proposes a method of preparing filled, modified and fiber reinforced thermoplastics by mixing polymers, additives, fillers and fibers in a twin screw extruder. Continuous fiber rovings are fed to the twin screw extruder at a fiber feed zone located downstream of the feed hopper for the polymer resin. Fiber types disclosed include glass and carbon.

Application Ser. No. 11/318,363, filed Dec. 13, 2005, notes that consistently feeding PET fibers into a compounding extruder is a problem encountered during the production of polypropylene (PP)-PET fiber composites. Conventional gravimetric or vibrational feeders used in the metering and conveying of polymers, fillers and additives into the extrusion compounding process, while effective in conveying pellets or powder, are not effective in conveying cut fiber. Another issue encountered during the production of PP-PET fiber composites is adequately dispersing the PET fibers into the PP matrix while still maintaining the advantageous mechanical properties imparted by the incorporation of the PET fibers. More particularly, extrusion compounding screw configurations may impact the dispersion of PET fibers within the PP matrix, and extrusion compounding processing conditions may impact not only the mechanical properties of the matrix polymer, but also the mechanical properties of the PET fibers. Application Ser. No. 11/318,363, filed Dec. 13, 2005, proposes solutions to these problems.

U.S. Pat. No. 6,923,495 proposes a front body structure of a vehicle and an assembling method therefore having head-lamp units disposed at both vehicular widthwise sides of a radiator core support panel, positionally adjustable to the front fenders, thereby allowing attachment of the head-lamp units to the front fenders. A radiator core support panel made of an unspecified plastic material is also proposed.

U.S. Pat. No. 6,948,769 proposes a vehicle front end structure having a firewall and a pair of hood ledge structures that extend in a cantilevered manner. A front end module is fixedly coupled to the hood ledge structures at a pair of upper attachment points and at pair of lower attachment points. The front end module and the hood ledge structures are provided with mating guide members that have horizontal and vertical guide portions to aid in the installation of the front end module on the hood ledge structures.

U.S. Patent Publication No. 2004/0180193 proposes a resin composition comprising a thermoplastic resin, and an oxidized compound having a hydrophobic group and a polar group on the surface thereof. The resin composition is said to have high rigidity, dimensional stability, transparency and impact strength by dispersing the oxidized compound having the hydrophobic group and the polar group on the surface thereof in the thermoplastic resin. The resin composition is proposed for use in various molded products and parts of a vehicle.

U.S. Patent Publication No. 2005/0252704 proposes a carrier structure that has an inside member formed of a plastic material, an outer member formed of steel coupled to the inside member, and a bracket formed at a lower end of the outer member for reducing the weight of the carrier. The bracket is coupled to the inner member at a portion for mounting a radiator by an over-molding method, thereby enhancing the mounting strength of a cooling system.

U.S. Patent Publication No. 2003/02118356 proposes a structure for mounting a horizontal hood latch to an automobile. The structure includes an upper panel of a front-end module and a bracket over-molded onto the upper panel of the front-end module. A pair of through-openings are provided on opposite side portions of the bracket that allow both surfaces of the bracket to be coated by a plastic material and the bracket to be mounted onto the upper panel, as the plastic material is poured thereon.

Despite these advances in the art, there remains a need for a front end assembly that is both lightweight, modular in construction and, therefore, easy to assemble in the assembly plant, or elsewhere, and yet relatively inexpensive.

### SUMMARY

Provided is a fiber reinforced polypropylene composite front end module. The front end module includes a radiator mounting frame molded from a composition comprising at least 30 wt % polypropylene based resin, from 10 to 60 wt % organic fiber, from 0 to 40 wt % inorganic filler, and from 0 to 0.1 wt % lubricant, based on the total weight of the composition, said radiator mounting frame having at least a first side and a second side.

In another aspect, a process for producing fiber reinforced polypropylene composite front end modules is also provided. The process includes the step of injection molding a composition to form the front end module, the front end module having a radiator mounting frame having at least a first side and a second side, wherein the composition comprises at least 30 wt % polypropylene, from 10 to 60 wt % organic fiber, from 0 to 40 wt % inorganic filler, and from 0 to 0.1 wt % lubricant, based on the total weight of the composition.

In yet another aspect, provided is a process for making a fiber reinforced polypropylene composite front end module, comprising the steps of: feeding into a twin screw extruder hopper at least about 25 wt % of a polypropylene based resin with a melt flow rate of from about 20 to about 1500 g/10 minutes; continuously feeding by unwinding from one or more spools into the twin screw extruder hopper from about 5 wt % to about 40 wt % of an organic fiber; feeding into a twin screw extruder from about 10 wt % to about 60 wt % of an inorganic filler; extruding the polypropylene based resin, the organic fiber, and the inorganic filler through the twin screw extruder to form a fiber reinforced polypropylene composite melt; cooling the fiber reinforced polypropylene composite melt to form a solid fiber reinforced polypropylene composite; injection molding the fiber reinforced polypropylene composite to form the front end module, the front end module having a radiator mounting frame having an first side and a second side.

In still yet another aspect, provided is a process for making a fiber reinforced polypropylene composite front end module, comprising the steps of: feeding into a twin screw extruder hopper at least about 25 wt % of a polypropylene based resin with a melt flow rate of from about 20 to about 1500 g/10 minutes; continuously feeding ⅛ inch to 1 inch long polyester fibers into a twin screw extruder hopper from about 5 wt % to about 40 wt % of an organic fiber; feeding into a twin screw extruder from about 10 wt % to about 60 wt % of an inorganic filler; extruding the polypropylene based resin, the organic fiber, and the inorganic filler through the twin screw extruder to form a fiber reinforced polypropylene composite melt; cooling the fiber reinforced polypropylene composite melt to form a solid fiber reinforced polypropylene composite; injection molding the fiber reinforced polypropylene composite to form the front end module, the front end module having a radiator mounting frame having an first side and a second side.

It has been found that high quality composite front end modules can be produced from substantially lubricant-free fiber reinforced polypropylene compositions, the resultant modules possessing a flexural modulus of at least 300,000 psi (2.068 GPa) and exhibiting ductility during instrumented impact testing. Particularly surprising is the ability to make such composite front end modules using a wide range of polypropylenes as the matrix material, including some polypropylenes that, without fiber, are very brittle.

It has also been found that organic fiber may be fed into a twin screw compounding extruder by continuously unwinding from one or more spools into the feed hopper of the twin screw extruder, and then chopped into ¼ inch to 1 inch (6.35 to 25.4 mm) lengths by the twin screws to form a fiber reinforced polypropylene based composite for use in producing high quality composite front end modules. Alternatively, it has also been found that organic fiber may be fed into a twin screw compounding extruder by continuously feeding ⅛ inch to 1 inch (3.18 to 25.4 mm) long polyester fibers into a twin screw extruder hopper to form a fiber reinforced polypropylene based composite for use in producing high quality composite front end modules.

Numerous advantages result from the composite front end modules and the method of making disclosed herein and the uses/applications therefore.

For example, in exemplary forms disclosed herein, the polypropylene fiber composite front end modules exhibit improved instrumented impact resistance.

In a further exemplary form disclosed herein, the polypropylene fiber composite front end modules exhibit improved flexural modulus.

In a further exemplary form disclosed herein, the polypropylene fiber composite front end modules do not splinter during instrumented impact testing.

In yet a further exemplary form of the present disclosure, the disclosed polypropylene fiber composite front end modules exhibit fiber pull out during instrumented impact testing without the need for lubricant additives.

In yet a further exemplary form of the present disclosure, the disclosed polypropylene fiber composite front end modules exhibit a higher heat distortion temperature compared to rubber toughened polypropylene.

In yet a further exemplary form of the present disclosure, the disclosed polypropylene fiber composite front end modules exhibit a lower flow and cross flow coefficient of linear thermal expansion compared to rubber toughened polypropylene.

In still yet a further exemplary form of the present disclosure, the disclosed polypropylene fiber composite front end modules exhibit the ability to provide excellent surface finishes.

In still yet a further exemplary form of the present disclosure, the disclosed polypropylene fiber composite front end modules exhibit the requisite stiffness characteristics necessary for use as a load bearing member.

These and other advantages, features and attributes of the disclosed fiber reinforced polypropylene composite front end modules and method of making fiber reinforced polypropylene composite front end modules and their advantageous applications and/or uses will be apparent from the detailed description that follows, particularly when read in conjunction with the figures appended hereto.

### BRIEF DESCRIPTION OF THE DRAWINGS

FIG. 1 is an exploded view of a front end construction of a vehicle frame having a fiber reinforced polypropylene composite front end module, shown with certain conventional under hood components;

FIG. 2 is a perspective view of the fiber reinforced polypropylene composite front end module of FIG. 1, in a state of being attached to the vehicle frame;

FIG. 3 is an enlarged partial perspective view of another form of a fiber reinforced polypropylene composite front end module, shown with certain conventional under hood components, in accordance with the present disclosure;

FIG. 4 depicts an exemplary schematic of the process for making fiber reinforced polypropylene composite front end modules of the type disclosed herein;

FIG. 5 depicts an exemplary schematic of a twin screw extruder with a downstream feed port for making fiber reinforced polypropylene composite front end modules of the type disclosed herein; and

FIG. 6 depicts an exemplary schematic of a twin screw extruder screw configuration for making fiber reinforced polypropylene composite front end modules of the type disclosed herein.

### DETAILED DESCRIPTION

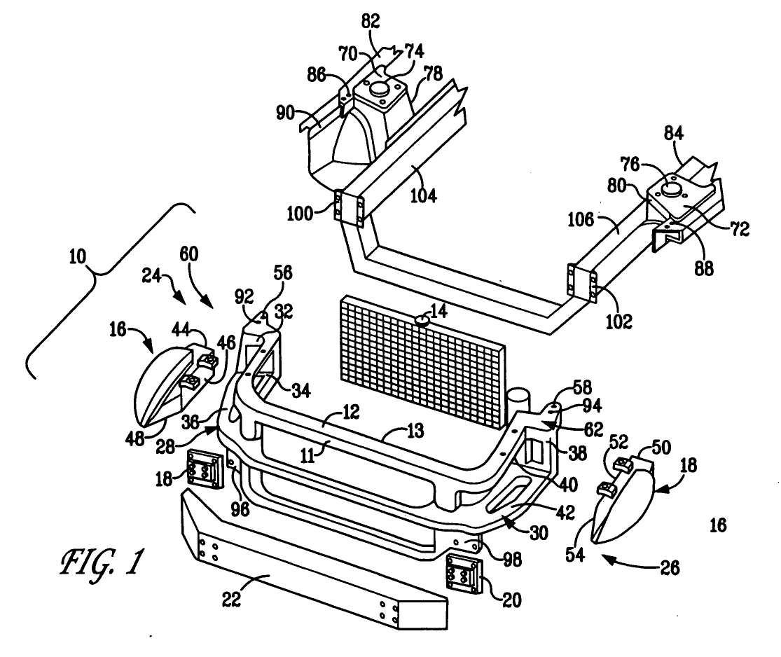

All numerical values with the detailed description and the claims herein are understood as modified by “about.” Reference is now made to FIGS. 1-6, wherein like numerals are used to designate like parts throughout.

Disclosed herein are fiber reinforced polypropylene composite front end modules and a process for making same. Composite vehicle front end modules of the type contemplated herein are generically depicted in FIGS. 1-3. All of the contemplated forms permit the preassembly of important parts, such as a radiator core, fan assembly, headlight modules, etc. and permit this without the presence of the actual vehicle, at least in the case of an automobile or truck, independently of the main assembly line.

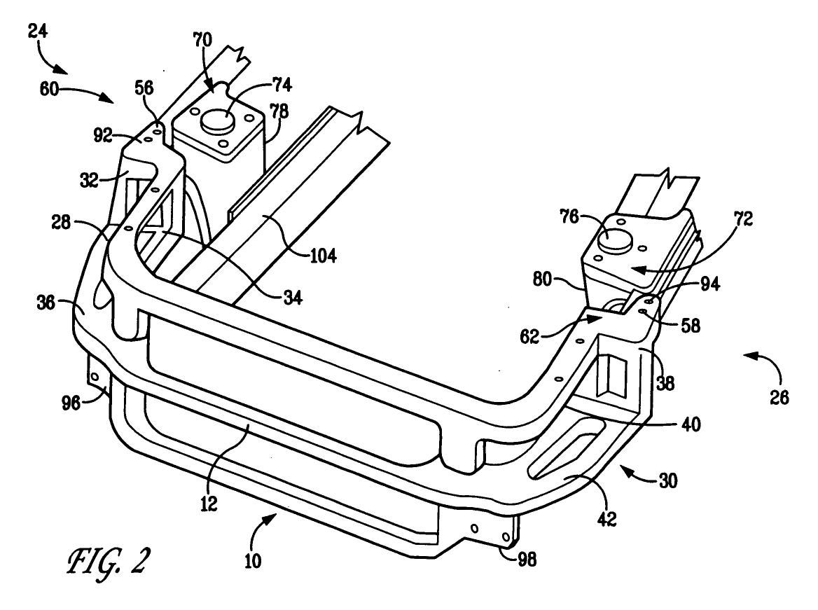

Referring now to FIGS. 1 and 2, one form of a fiber reinforced polypropylene composite front end module 10 is generally depicted. The front end module 10 includes a radiator mounting frame 12 molded from a composition comprising at least 30 wt % polypropylene based resin, from 10 to 60 wt % organic fiber, from 0 to 40 wt % inorganic filler, and from 0 to 0.1 wt % lubricant, based on the total weight of the composition. The radiator mounting frame 12, as shown, has at least a first side 11 and a second side 13.

Radiator mounting frame 12 may be formed as a single piece and formed by injection molding. The front end module 10 may also include a radiator 14, and may include a pair of head lamps 16 and 18 and, optionally, a pair of bumper mounts 18 and 20 and a bumper structure 22. Other engine compartment components, of course, may also be included, as those skilled in the art will readily recognize. The parts may be assembled together and modularized. As may be appreciated, the modularized parts are not limited to those described above but can include other parts such as a condenser and, some of the parts described above can be deleted from the fiber reinforced polypropylene composite front end module 10.

The fiber reinforced polypropylene composite radiator mounting frame 12 is generally in the form of a framework and may be of unitary construction or, alternatively comprised of a plurality of frame members joined together. As may best seen by reference to FIG. 2, the fiber reinforced polypropylene composite radiator mounting frame 12 may have at its opposite lateral end portions 24 and 26, having a pair of support structures 28 and 30 for supporting head lamps 16 and 18, respectively. Of course, a wide variety of other configurations is contemplated and within the scope of the fiber reinforced polypropylene composite front end modules disclosed herein. Support structure 28 may be further provided with supporting surfaces 32, 34 and 36, for supporting three surfaces of the head lamp 16, i.e., a rear surface 44, an inboard side surface 46, facing widthwise of the vehicle and a lower surface 48, respectively. Likewise, support structure 30 may also be provided with supporting surfaces 38, 40 and 42 for supporting three surfaces of the head lamp 18, i.e., a rear surface 50, an inboard side surface 52, facing widthwise of the vehicle and a lower surface 54, respectively.

Support structure 28 is elongated longitudinally of the vehicle body so as to extend from the front terminal section to the rear terminal section 56 of lateral end portion 24 of the fiber reinforced polypropylene composite radiator mounting frame 12. Likewise, support structure 30 is elongated longitudinally of the vehicle body so as to extend from the front terminal section to the rear terminal section 58 of lateral end portion 26 of the fiber reinforced polypropylene composite radiator mounting frame 12. The rear terminal sections 56 and 58 of the lateral end portions 24 and 26 of the fiber reinforced polypropylene composite radiator mounting frame 12 are adapted to serve as attaching portions 60 and 62, respectively of the fiber reinforced polypropylene composite front end module 10, which are to be attached to the vehicle body. The lateral end portions 24 and 26 are elongated and extended rearward so as to allow rear terminal sections 56 and 58 to be positioned adjacent suspension attaching portions 30 of the vehicle body, respectively.

As shown in FIGS. 1 and 2, each suspension attaching portion 70 and 72 is constituted by a strut tower made up of a suspension tower upper 74 and 76, respectively, a suspension tower lower 78 and 80, respectively, and mounting members 82 and 84. Also provided are attaching holes 86 and 88, located at an upper horizontal portion of mounting members 82 and 84. Further, while many configurations are contemplated, in this form, a pair of hood ledge lower front panels 90 (only one being shown) may optionally be provided so as to extend forward from the suspension attaching portions 70 and 72.

The fiber reinforced polypropylene composite front end module 10 is attached at the attaching portions 60 and 62 to the portions of the vehicle body adjacent the suspension attaching portions 70 and 72, by aligning the attaching holes 92 and 94 at the rear terminal sections 56 and 58, respectively, of the above described opposite lateral end portions 24 and 26 with the respective attaching holes 86 and 88 and bolting the lateral end portions 26 and 28 and the suspension attaching portions 70 and 72 together. Of course, a wide variety of configurations and means for assembly are contemplated and within the scope of the disclosure herein. The fiber reinforced polypropylene composite front end module 10 is further attached at a pair of attaching portions 96 and 98 to the vehicle body. The attaching portions 96 and 98 are located at the laterally opposed, front terminal, lower sections of the fiber reinforced polypropylene composite radiator mounting frame 12, i.e., located adjacent the front terminal sections of the lateral end portions 24 and 26. More specifically, the fiber reinforced polypropylene composite front end module 10 is attached at the attaching portions 96 and 98 to the vehicle body by placing the attaching portions 96 and 98 on the front ends 100 and 102 of a pair of front side members 104 and 106 of the vehicle body and bolting the attaching portions 96 and 98 and the front ends 100 and 102 together.

In the forgoing construction, it will be understood that the rear terminal sections 56 and 58 of the opposite lateral end portions 24 and 26 of the fiber reinforced polypropylene composite radiator mounting frame 12 of the fiber reinforced polypropylene composite front end module 10 are adapted to be attached to the vehicle body portions adjacent the suspension attaching portions 70 and 72 which may be positioned in place at the time of assembly of the vehicle body. Thus, the attaching holes 86 and 88 of the suspension attaching portions 70 and 72 can be positioned accurately, thus making it possible to attach the front end module 10 to the vehicle body with ease and accuracy. It will be further understood that the arrangement disclosed herein enables fiber reinforced polypropylene composite front end module 10 to be easily detached and reattached for repair or other service.

Optionally, since the lateral end portions 24 and 26 of the fiber reinforced polypropylene composite radiator mounting frame 12 of the fiber reinforced polypropylene composite front end module 10 are extended rearward so as to enable the rear terminal sections 56 and 58 to be positioned adjacent the suspension attaching portions 70 and 72, the metallic hood ledge lower front panels 90 of the vehicle body, may advantageously be dispensed with, thus making it possible to make the vehicle lighter in weight.

Also, since the lateral end portions 24 and 26 of the fiber reinforced polypropylene composite radiator mounting frame 12 of the fiber reinforced polypropylene composite front end module 10 are provided with the supporting structures 28 and 30 having the three-dimensionally arranged supporting surfaces 32 through 42, it becomes possible to further the improve the rigidity of the opposite lateral end portions 24 and 26 of the fiber reinforced polypropylene composite radiator mounting frame 12, which constitute the attaching portions 60 and 62 of the fiber reinforced polypropylene composite front end module 10.

Likewise, since the supporting structures 28 and 30 are extended rearward so as to allow the rear terminations thereof to be positioned adjacent the rear terminal sections 56 and 58 of the opposite lateral end portions 24 and 26, the rigidity of the opposite lateral end portions 24 and 26 of the fiber reinforced polypropylene composite radiator mounting frame 12 when attached to the vehicle body can be improved further.

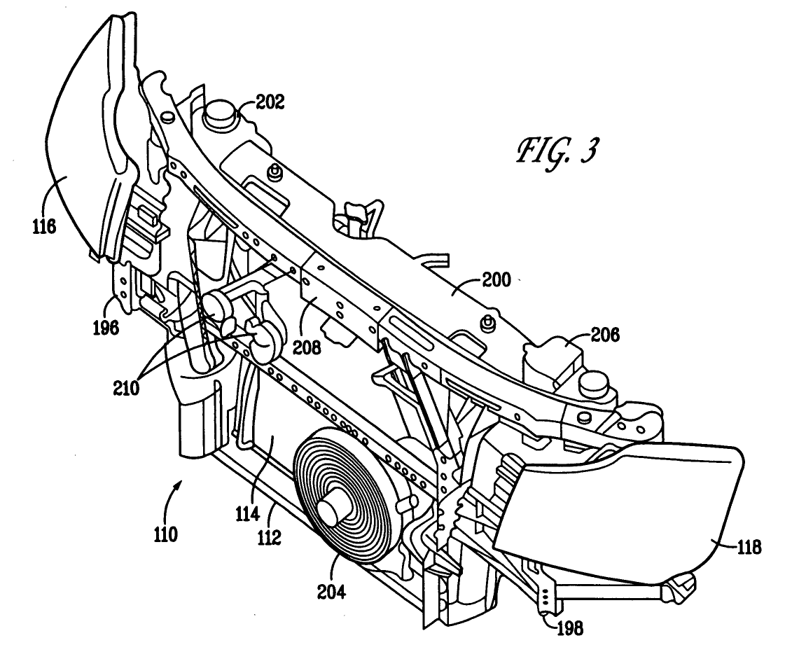

Referring now to FIG. 3, another form, fully assembled, of a fiber reinforced polypropylene composite front end module 110 is depicted. Fiber reinforced polypropylene composite front end module 110 includes a fiber reinforced polypropylene composite radiator mounting frame 112. The radiator mounting frame 112 may be formed as a single piece by injection molding. The front end module 110 also includes a radiator 114 and a pair of head lamps 116 and 118 and, optionally, a pair of bumper mounting brackets 196 and 198 for mounting a bumper structure (not shown). Other engine compartment components are also included in the assembly, such as a radiator shroud 200, a radiator overflow bottle 202 and an electrically powered radiator fan 204. As shown, a windshield washer container 206 may also be affixed to the fiber reinforced polypropylene composite radiator mounting frame 112. Moreover, owing to the unique properties of the fiber reinforced polypropylene composite front end module 110, a hood latch mechanism 208 may also be directly mounted to the fiber reinforced polypropylene composite radiator mounting frame 112. The parts may be assembled together and modularized. As may be appreciated, the modularized parts are not limited to those described above but can include other parts such as a condenser and, some of the parts described above can be deleted from the fiber reinforced polypropylene composite front end module 110.

As with the form depicted in FIGS. 1 and 2, fiber reinforced polypropylene composite radiator mounting frame 112 is generally in the form of a framework and may be of unitary construction or, alternatively comprised of a plurality of frame members joined together.

Advantageously, the preassembly of the fiber reinforced polypropylene composite front end modules disclosed herein may be carried out independently of the main assembly line on an ancillary or preassembly line or optionally at a different factory. As may be appreciated, owing to the unique characteristics of the fiber reinforced polypropylene composites contemplated herein, a fiber reinforced polypropylene composite front end module can optionally be integrally molded together with an outer body panel, for example, a front end spoiler or fascia portion (not shown). Alternatively, a single fiber reinforced polypropylene composite front end module can employ a plurality of smaller fiber reinforced polypropylene composite front end modules, e.g., a module for the radiator and modules for containing electrical components, such as fans, headlights and/or other lights. These and other variations are within the scope of this disclosure.

As will be described in more detail below, the process to produce front end modules from PP/PET can use standard injection molding equipment available in the market.

Advantageously, the fiber reinforced polypropylene composite front end modules contemplated herein are molded from a composition comprising a combination of a polypropylene based matrix with organic fiber and inorganic filler, which in combination yield front end modules molded from the compositions with a flexural modulus of at least 300,000 psi (2.068 GPa) and ductility during instrumented impact testing (15 mph, −29° C., 25 lbs). The fiber reinforced polypropylene composite front end modules employ a polypropylene based matrix polymer with an advantageous high melt flow rate that does not sacrifice impact resistance. In addition, the fiber reinforced polypropylene composite front end modules disclosed herein do not splinter during instrumented impact testing.

The fiber reinforced polypropylene composite front end modules disclosed herein simultaneously have desirable stiffness, as measured by having a flexural modulus of at least 300,000 psi (2.068 GPa), and toughness, as measured by exhibiting ductility during instrumented impact testing. The fiber reinforced polypropylene composite front end modules contemplated herein have a flexural modulus of at least 350,000 psi (2.413 GPa), or at least 370,000 psi (2.551 GPa), or at least 390,000 psi (2.689 GPa), or at least 400,000 psi (2.758 GPa), or at least 450,000 psi (3.103 GPa). Still more particularly, the fiber reinforced polypropylene composite front end modules have a flexural modulus of at least 600,000 psi (4.137 GPa), or at least 800,000 psi (5.516 GPa). It is also believed that having a weak interface between the polypropylene matrix and the fiber contributes to fiber pullout; and, therefore, may enhance toughness. Thus, there is no need to add modified polypropylenes to enhance bonding between the fiber and the polypropylene matrix, although the use of modified polypropylene may be advantageous to enhance the bonding between a filler, such as talc or wollastonite and the matrix. In addition, in one form, there is no need to add lubricant to weaken the interface between the polypropylene and the fiber to further enhance fiber pullout. Some forms also display no splintering during instrumented dart impact testing, which yield a further advantage of not subjecting a person in close proximity to the impact to potentially harmful splintered fragments.

The fiber reinforced polypropylene composite front end modules disclosed herein are formed from a composition that includes at least 30 wt %, based on the total weight of the composition, of polypropylene as the matrix resin. In a particular form, the polypropylene is present in an amount of at least 30 wt %, or at least 35 wt %, or at least 40 wt %, or at least 45 wt %, or at least 50 wt %, or in an amount within the range having a lower limit of 30 wt %, or 35 wt %, or 40 wt %, or 45 wt %, or 50 wt %, and an upper limit of 75 wt %, or 80 wt %, based on the total weight of the composition. In another form, the polypropylene is present in an amount of at least 25 wt %.

The polypropylene used as the matrix resin in the fiber reinforced polypropylene composite front end modules is not particularly restricted and is generally chosen from propylene homopolymers, propylene-ethylene random copolymers, propylene-α-olefin random copolymers, propylene block copolymers, propylene impact copolymers, and combinations thereof. In a particular form, the polypropylene is a propylene homopolymer. In another particular form, the polypropylene is a propylene impact copolymer comprising from 78 to 95 wt % homopolypropylene and from 5 to 22 wt % ethylene-propylene rubber, based on the total weight of the impact copolymer. In a particular aspect of this form, the propylene impact copolymer comprises from 90 to 95 wt % homopolypropylene and from 5 to 10 wt % ethylene-propylene rubber, based on the total weight of the impact copolymer.

The polypropylene of the matrix resin may have a melt flow rate of from 20 to 1500 g/10 min. In a particular form, the melt flow rate of the polypropylene matrix resin is greater than 100 g/10 min, and still more particularly greater than or equal to 400 g/10 min. In yet another form, the melt flow rate of the polypropylene matrix resin is 1500 g/10 min. The higher melt flow rate permits for improvements in processability, throughput rates, and higher loading levels of organic fiber and inorganic filler without negatively impacting flexural modulus and impact resistance.

In a particular form, the matrix polypropylene contains less than 0.1 wt % of a modifier, based on the total weight of the polypropylene. Typical modifiers include, for example, unsaturated carboxylic acids, such as acrylic acid, methacrylic acid, maleic acid, itaconic acid, fumaric acid or esters thereof, maleic anhydride, itaconic anhydride, and derivates thereof. In another particular form, the matrix polypropylene does not contain a modifier. In still yet another particular form, the polypropylene based polymer further includes from 0.1 wt % to less than 10 wt % of a polypropylene based polymer modified with a grafting agent. The grafting agent includes, but is not limited to, acrylic acid, methacrylic acid, maleic acid, itaconic acid, fumaric acid or esters thereof, maleic anhydride, itaconic anhydride, and combinations thereof.

The polypropylene may further contain additives commonly known in the art, such as dispersants, lubricants, flame-retardants, antioxidants, antistatic agents, light stabilizers, ultraviolet light absorbers, carbon black, nucleating agents, plasticizers, and coloring agents such as dyes or pigments. The amount of additive, if present, in the polypropylene matrix is generally from 0.1 wt %, or 0.5 wt %, or 2.5 wt %, to 7.5 wt %, or 10 wt %, based on the total weight of the matrix. Diffusion of additive(s) during processing may cause a portion of the additive(s) to be present in the fiber.

The fiber reinforced polypropylene composite front end module disclosed herein is not limited by any particular polymerization method for producing the matrix polypropylene, and the polymerization processes described herein are not limited by any particular type of reaction vessel. For example, the matrix polypropylene can be produced using any of the well known processes of solution polymerization, slurry polymerization, bulk polymerization, gas phase polymerization, and combinations thereof. Furthermore, the disclosure is not limited to any particular catalyst for making the polypropylene, and may, for example, include Ziegler-Natta or metallocene catalysts.

The fiber reinforced polypropylene composite front end modules contemplated herein are formed from compositions that also generally include at least 10 wt %, based on the total weight of the composition, of an organic fiber. In a particular form, the fiber is present in an amount of at least 10 wt %, or at least 15 wt %, or at least 20 wt %, or in an amount within the range having a lower limit of 10 wt %, or 15 wt %, or 20 wt %, and an upper limit of 50 wt %, or 55 wt %, or 60 wt %, or 70 wt %, based on the total weight of the composition. In another form, the organic fiber is present in an amount of at least 5 wt % and up to 40 wt %.

The polymer used as the fiber is not particularly restricted and is generally chosen from polyalkylene terephthalates, polyalkylene naphthalates, polyamides, polyolefins, polyacrylonitrile, and combinations thereof. In a particular form, the fiber comprises a polymer chosen from polyethylene terephthalate (PET), polybutylene terephthalate, polyamide and acrylic. In another particular form, the organic fiber comprises PET.

In one form, the fiber is a single component fiber. In another form, the fiber is a multicomponent fiber, wherein the fiber is formed from a process in which at least two polymers are extruded from separate extruders and meltblown or spun together to form one fiber. In a particular aspect of this form, the polymers used in the multicomponent fiber are substantially the same. In another particular aspect of this form, the polymers used in the multicomponent fiber are different from each other. The configuration of the multicomponent fiber can be, for example, a sheath/core arrangement, a side-by-side arrangement, a pie arrangement, an islands-in-the-sea arrangement, or a variation thereof. The fiber may also be drawn to enhance mechanical properties via orientation, and subsequently annealed at elevated temperatures, but below the crystalline melting point to reduce shrinkage and improve dimensional stability at elevated temperature.

The length and diameter of the fibers employed in the fiber reinforced polypropylene composite front end modules contemplated herein are not particularly restricted. In a particular form, the fibers have a length of ¼ inch (6.35 mm), or a length within the range having a lower limit of ⅛ inch (3.18 mm), or ⅙ inch (4.23 mm), and an upper limit of ⅓ inch (8.47 mm), or ½ inch (12.7 mm). In another particular form, the diameter of the fibers is within the range having a lower limit of 10 μm and an upper limit of 100 μm.

The fiber may further contain additives commonly known in the art, such as dispersants, lubricants, flame-retardants, antioxidants, antistatic agents, light stabilizers, ultraviolet light absorbers, carbon black, nucleating agents, plasticizers, and coloring agents such as dyes or pigments.

The fiber used to make the fiber reinforced polypropylene composite front end modules disclosed herein is not limited by any particular fiber form. For example, the fiber can be in the form of continuous filament yarn, partially oriented yarn, or staple fiber. In another form, the fiber may be a continuous multifilament fiber or a continuous monofilament fiber.

The compositions employed in the fiber reinforced polypropylene composite front end modules disclosed herein optionally include inorganic filler in an amount of at least 1 wt %, or at least 5 wt %, or at least 10 wt %, or in an amount within the range having a lower limit of 0 wt %, or 1 wt %, or 5 wt %, or wt %, or 15 wt %, and an upper limit of 25 wt %, or 30 wt %, or 35 wt %, or 40 wt %, based on the total weight of the composition. In yet another form, the inorganic filler may be included in the polypropylene fiber composite in the range of from 10 wt % to 60 wt %. In a particular form, the inorganic filler is chosen from talc, calcium carbonate, calcium hydroxide, barium sulfate, mica, calcium silicate, clay, kaolin, silica, alumina, wollastonite, magnesium carbonate, magnesium hydroxide, magnesium oxysulfate, titanium oxide, zinc oxide, zinc sulfate, and combinations thereof. The talc may have a size of from 1 to 100 microns.

High aspect ratio talc may be used in the compositions employed in the fiber reinforced polypropylene composite front end modules contemplated. Although aspect ratio can be calculated by dividing the average particle diameter of the talc by the average thickness using a conventional microscopic method, this is a difficult and tedious technique. A particularly useful indication of aspect ratio is known in the art as “lamellarity index,” which is a ratio of particle size measurements. Therefore, as used herein, by “high aspect ratio” talc is meant talc having an average lamellarity index greater than or equal to 4 or greater than or equal to 5. A talc having utility in the compositions disclosed herein has a specific surface area of at least 14 square meters/gram.

In one particular form, at a high talc loading of up to 60 wt %, the polypropylene fiber composite exhibited a flexural modulus of at least 750,000 psi and no splintering during instrumented impact testing (15 mph, −29° C., 25 lbs). In another particular form, at a low talc loading of as low as 10 wt %, the polypropylene fiber composite exhibited a flexural modulus of at least 325,000 psi and no splintering during instrumented impact testing (15 mph, −29° C., and 25 lbs). In addition, wollastonite loadings of from 5 wt % to 60 wt % in the polypropylene fiber composite yielded an outstanding combination of impact resistance and stiffness.

In another particular form, a fiber reinforced polypropylene composition including a polypropylene based resin with a melt flow rate of 80 to 1500, 10 to 15 wt % of polyester fiber, and 50 to 60 wt % of inorganic filler displayed a flexural modulus of 850,000 to 1,200,000 psi and did not shatter during instrumented impact testing at −29 degrees centigrade, tested at 25 pounds and 15 miles per hour. The inorganic filler includes, but is not limited to, talc and wollastonite. This combination of stiffness and toughness is difficult to achieve in a polymeric based material. In addition, the fiber reinforced polypropylene composition has a heat distortion temperature at 66 psi of greater than 100 degrees centigrade, and a flow and cross flow coefficient of linear thermal expansion of 2.2×10⁻⁵ and 3.3×10⁻⁵ per degree centigrade respectively. In comparison, rubber toughened polypropylene has a heat distortion temperature of 94.6 degrees centigrade, and a flow and cross flow thermal expansion coefficient of 10×10⁻⁵ and 18.6×10⁻⁵ per degree centigrade respectively.

The fiber reinforced polypropylene composite front end modules are made by forming the fiber-reinforced polypropylene composition and then injection molding the composition to form the front end module. There is no limit with respect to the particular method for forming the compositions. For example, the compositions can be formed by contacting polypropylene, organic fiber, and optional inorganic filler in any of the well known processes of pultrusion or extrusion compounding. In a particular form, the compositions are formed in an extrusion compounding process. In a particular aspect of this form, the organic fibers are cut prior to being placed in the extruder hopper. In another particular aspect of this form, the organic fibers are fed directly from one or more spools into the extruder hopper.

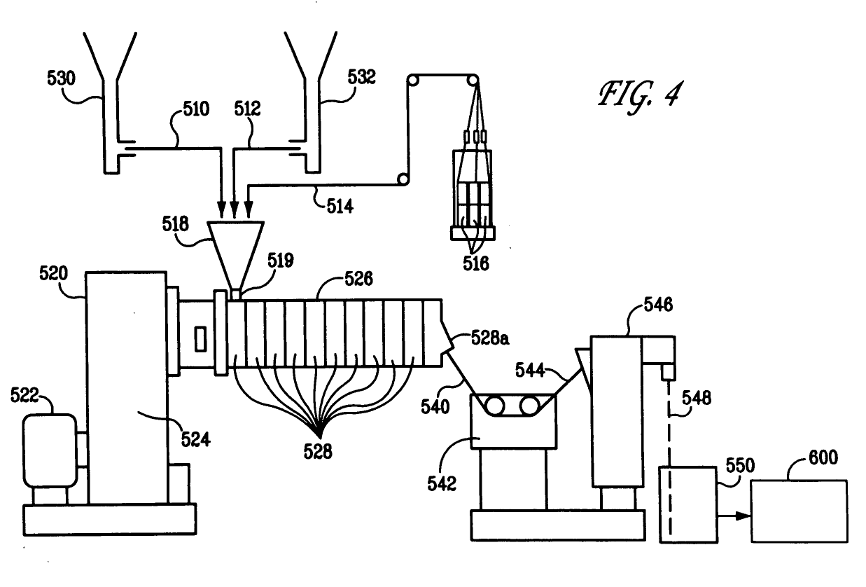

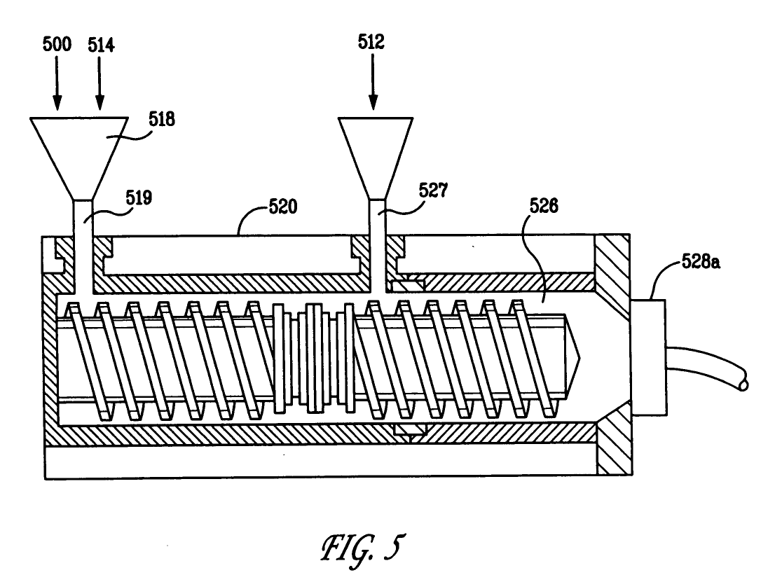

Referring now to FIG. 4, an exemplary schematic of the process for making fiber reinforced polypropylene composite front end modules of the instant disclosure is shown. Polypropylene based resin 510, inorganic filler 512, and organic fiber 514 continuously unwound from one or more spools 516 are fed into the extruder hopper 518 of a twin screw compounding extruder 520. The extruder hopper 518 is positioned above the feed throat 519 of the twin screw compounding extruder 520. The extruder hopper 518 may alternatively be provided with an auger (not shown) for mixing the polypropylene based resin 510 and the inorganic filler 512 prior to entering the feed throat 519 of the twin screw compounding extruder 520. In an alternative form, as depicted in FIG. 5, the inorganic filler 512 may be fed to the twin screw compounding extruder 520 at a downstream feed port 527 in the extruder barrel 526 positioned downstream of the extruder hopper 18, while the polypropylene based resin 510 and the organic fiber 514 are still metered into the extruder hopper 518.

Referring again to FIG. 4, polypropylene based resin 510 is metered to the extruder hopper 518 via a feed system 530 for accurately controlling the feed rate. Similarly, the inorganic filler 512 is metered to the extruder hopper 518 via a feed system 532 for accurately controlling the feed rate. The feed systems 530, 532 may be, but are not limited to, gravimetric feed system or volumetric feed systems. Gravimetric feed systems are may be used for accurately controlling the weight percentage of polypropylene based resin 510 and inorganic filler 512 being fed to the extruder hopper 518. The feed rate of organic fiber 514 to the extruder hopper 518 is controlled by a combination of the extruder screw speed, number of fiber filaments and the thickness of each filament in a given fiber spool, and the number of fiber spools 516 being unwound simultaneously to the extruder hopper 518. The higher the extruder screw speed measured in revolutions per minute (rpms), the greater will be the rate at which organic fiber 514 is fed to the twin screw compounding screw 520. The rate at which organic fiber 514 is fed to the extruder hopper also increases with the greater the number of filaments within the organic fiber 514 being unwound from a single fiber spool 516, the greater filament thickness, the greater the number fiber spools 516 being unwound simultaneously, and the rotations per minute of the extruder.

The twin screw compounding extruder 520 includes a drive motor 522, a gear box 524, an extruder barrel 526 for holding two screws (not shown), and a strand die 528. The extruder barrel 526 is segmented into a number of heated temperature controlled zones 528. As depicted in FIG. 4, the extruder barrel 526 includes a total of ten temperature control zones 528. The two screws within the extruder barrel 526 of the twin screw compounding extruder 520 may be intermeshing or non-intermeshing, and may rotate in the same direction (co-rotating) or rotate in opposite directions (counter-rotating). From a processing perspective, the melt temperature must be maintained above that of the polypropylene based resin 510, and far below the melting temperature of the organic fiber 514, such that the mechanical properties imparted by the organic fiber will be maintained when mixed into the polypropylene based resin 510. In one exemplary form, the barrel temperature of the extruder zones did not exceed 154° C. when extruding PP homopolymer and PET fiber, which yielded a melt temperature above the melting point of the PP homopolymer, but far below the melting point of the PET fiber. In another exemplary form, the barrel temperatures of the extruder zones are set at 185° C. or lower.

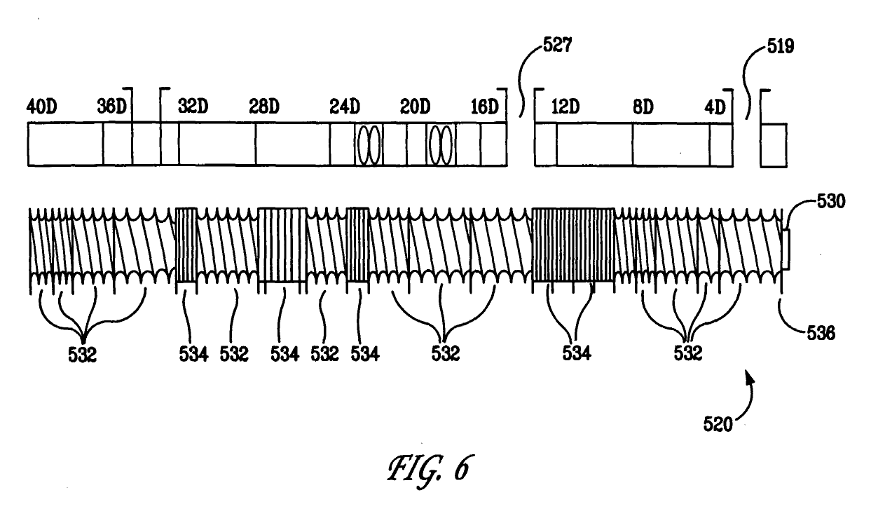

An exemplary schematic of a twin screw compounding extruder 520 screw configuration for making fiber reinforced polypropylene composites is depicted in FIG. 6. The feed throat 519 allows for the introduction of polypropylene based resin, organic fiber, and inorganic filler into a feed zone of the twin screw compounding extruder 520. The inorganic filler may be optionally fed to the extruder 520 at the downstream feed port 527. The twin screws 530 include an arrangement of interconnected screw sections, including conveying elements 532 and kneading elements 534. The kneading elements 534 function to melt the polypropylene based resin, cut the organic fiber lengthwise, and mix the polypropylene based melt, chopped organic fiber and inorganic filler to form a uniform blend. More particularly, the kneading elements function to break up the organic fiber into ⅛ inch to 1 inch (3.18 to 25.4 mm) fiber lengths. A series of interconnected kneading elements 534 is also referred to as a kneading block. U.S. Pat. No. 4,824,256 to Haring, et al., herein incorporated by reference in its entirety, discloses co-rotating twin screw extruders with kneading elements. The first section of kneading elements 534 located downstream from the feed throat is also referred to as the melting zone of the twin screw compounding extruder 520. The conveying elements 532 function to convey the solid components, melt the polypropylene based resin, and convey the melt mixture of polypropylene based polymer, inorganic filler and organic fiber downstream toward the strand die 528 (see FIG. 4) at a positive pressure.

Alternatively, rather than unwinding and feeding a continuous fiber to the twin screw extruder and using the kneading elements to break up the fiber, ⅛ inch to 1 inch (3.18 to 25.4 mm) long polyester fibers may be fed into a twin screw extruder hopper.

The position of each of the screw sections as expressed in the number of diameters (D) from the start 536 of the extruder screws 530 is also depicted in FIG. 6. The extruder screws in FIG. 6 have a length to diameter ratio of 40/1, and at a position 32D from the start 536 of screws 530, there is positioned a kneading element 534. The particular arrangement of kneading and conveying sections is not limited to that as depicted in FIG. 6, however one or more kneading blocks consisting of an arrangement of interconnected kneading elements 534 may be positioned in the twin screws 530 at a point downstream of where organic fiber and inorganic filler are introduced to the extruder barrel. The twin screws 530 may be of equal screw length or unequal screw length. Other types of mixing sections may also be included in the twin screws 530, including, but not limited to, Maddock mixers, and pin mixers.

Referring once again to FIG. 4, the uniformly mixed fiber reinforced polypropylene composite melt comprising polypropylene based polymer 510, inorganic filler 512, and organic fiber 514 is metered by the extruder screws to a strand die 528 for forming one or more continuous strands 540 of fiber reinforced polypropylene composite melt. The one or more continuous strands 540 are then passed into water bath 542 for cooling them below the melting point of the fiber reinforced polypropylene composite melt to form a solid fiber reinforced polypropylene composite strands 544. The water bath 542 is typically cooled and controlled to a constant temperature much below the melting point of the polypropylene based polymer. The solid fiber reinforced polypropylene composite strands 544 are then passed into a pelletizer or pelletizing unit 546 to cut them into fiber reinforced polypropylene composite resin 5548 measuring from ¼ inch to 1 inch (6.35 to 25.4 mm) in length. The fiber reinforced polypropylene composite resin 548 may then be accumulated in containers 550 or alternatively conveyed to silos for storage and eventually conveyed to injection molding line 600, for molding into the fiber reinforced polypropylene composite front end modules of the type disclosed herein.

The fiber reinforced polypropylene composite front end modules disclosed herein and the advantages thereto are further illustrated by means of the following examples, without limiting the scope thereof.

### Test Methods

Fiber reinforced polypropylene compositions described herein were injection molded at 2300 psi pressure, 401° C. at all heating zones as well as the nozzle, with a mold temperature of 60° C.

Flexural modulus data was generated for injected molded samples produced from the fiber reinforced polypropylene compositions described herein using the ISO 178 standard procedure.

Instrumented impact test data was generated for injected mold samples produced from the fiber reinforced polypropylene compositions described herein using ASTM D3763. Ductility during instrumented impact testing (test conditions of 15 mph, −29° C., and 25 lbs) is defined as no splintering of the sample.

### EXAMPLES

PP3505G is a propylene homopolymer commercially available from ExxonMobil Chemical Company of Baytown, Tex. The MFR (2.16 kg, 230° C.) of PP3505G was measured according to ASTM D1238 to be 400 g/10 min.

PP7805 is an 80 MFR propylene impact copolymer commercially available from ExxonMobil Chemical Company of Baytown, Tex.

PP8114 is a 22 MFR propylene impact copolymer containing ethylene-propylene rubber and a plastomer, and is commercially available from ExxonMobil Chemical Company of Baytown, Tex.

PP8224 is a 25 MFR propylene impact copolymer containing ethylene-propylene rubber and a plastomer, and is commercially available from ExxonMobil Chemical Company of Baytown, Tex.

PO1020 is 430 MFR maleic anhydride functionalized polypropylene homopolymer containing 0.5-1.0 weight percent maleic anhydride.

Cimpact CB7 is a surface modified talc, V3837 is a high aspect ratio talc, and Jetfine 700 C is a high surface area talc, all available from Luzenac America Inc. of Englewood, Colo.

### Illustrative Examples 1-8

Varying amounts of PP3505G and 0.25″ long polyester fibers obtained from Invista Corporation were mixed in a Haake single screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact under standard automotive conditions for interior parts (25 lbs, at 15 MPH, at −29° C.). The total energy absorbed and impact results are given in Table 1.

TABLE 1

| | wt % | wt % | Total Energy | Instrumented |
|---|---|---|---|---|
| Example # | PP3505G | Fiber | (ft-lbf) | Impact Test Results |
| 1 | 65 | 35 | 8.6 ± 1.1 | ductile* |
| 2 | 70 | 30 | 9.3 ± 0.6 | ductile* |
| 3 | 75 | 25 | 6.2 ± 1.2 | ductile* |
| 4 | 80 | 20 | 5.1 ± 1.2 | ductile* |
| 5 | 85 | 15 | 3.0 ± 0.3 | ductile* |
| 6 | 90 | 10 | 2.1 ± 0.2 | ductile* |
| 7 | 95 | 5 | 0.4 ± 0.1 | brittle** |
| 8 | 100 | 0 | <0.1 | brittle*** |

*Examples 1-6: samples did not shatter or split as a result of impact, with no pieces coming off of the specimen.
**Example 7: pieces broke off of the sample as a result of the impact
***Example 8: samples completely shattered as a result of impact.

### Illustrative Examples 9-14

In Examples 9-11, 35 wt % PP7805, 20 wt % Cimpact CB7 talc, and 45 wt % 0.25″ long polyester fibers obtained from Invista Corporation, were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for instrumented impact. The total energy absorbed and impact results are given in Table 2.

In Examples 12-14, PP8114 was extruded and injection molded under the same conditions as those for Examples 9-11. The total energy absorbed and impact results are given in Table 2.

TABLE 2

| | | | |
|---|---|---|---|
| | | Total | Instrumented |
| | Impact Conditions/Applied | Energy | Impact Test |
| Example # | Energy | (ft-lbf) | Results |

35 wt % PP7805 (70 MFR), 20 wt % talc, 45 wt % fiber

| | | | |
|---|---|---|---|
| 9 | −29° C., 15 MPH, 25 lbs/192 ft-lbf | 16.5 | ductile* |
| 10 | −29° C., 28 MPH, 25 lbs/653 ft-lbf | 14.2 | ductile* |
| 11 | −29° C., 21 MPH, 58 lbs/780 ft-lbf | 15.6 | ductile* |

100 wt % PP8114 (22 MFR)

| | | | |
|---|---|---|---|
| 12 | −29° C., 15 MPH, 25 lbs/192 ft-lbf | 32.2 | ductile* |
| 13 | −29° C., 28 MPH, 25 lbs/653 ft-lbf | 2.0 | brittle** |
| 14 | −29° C., 21 MPH, 58 lbs/780 ft-lbf | 1.7 | brittle** |

*Examples 9-12: samples did not shatter or split as a result of impact, with no pieces coming off of the specimen.
**Examples 13-14: samples shattered as a result of impact.

### Illustrative Examples 15-16

A Leistritz ZSE27 HP-60D 27 mm twin screw extruder with a length to diameter ratio of 40:1 was fitted with six pairs of kneading elements 12″ from the die exit to form a kneading block. The die was ¼″ in diameter. Strands of continuous 27,300 denier PET fibers were fed directly from spools into the hopper of the extruder, along with PP7805 and talc. The kneading elements in the kneading block in the extruder broke up the fiber in situ. The extruder speed was 400 revolutions per minute, and the temperatures across the extruder were held at 190° C. Injection molding was done under conditions similar to those described for Examples 1-14. The mechanical and physical properties of the sample were measured and are compared in Table 3 with the mechanical and physical properties of PP8224.

The instrumented impact test showed that in both examples there was no evidence of splitting or shattering, with no pieces coming off the specimen. In the notched charpy test, the PET fiber-reinforced PP7805 specimen was only partially broken, and the PP8224 specimen broke completely.

TABLE 3

| | Example 15 | |
|---|---|---|
| Test | PET fiber-reinforced | Example 16 |
| (Method) | PP7805 with talc | PP8224 |
| Flexural Modulus, Chord | 525,190 psi | 159,645 psi |
| (ISO 178) | | |
| Instrumented Impact at −30° C. | 6.8 J | 27.5 J |
| Energy to maximum load | | |
| 100 lbs at 5 MPH | | |
| (ASTM D3763) | | |
| Notched Charpy Impact at | 52.4 kJ/m² | 5.0 kJ/m² |
| −40° C. | | |
| (ISO 179/1eA) | | |
| Heat Deflection Temperature | 116.5° C. | 97.6° C. |
| at 0.45 Mpa, edgewise | | |
| (ISO 75) | | |
| Coefficient of Linear Thermal | 2.2/12.8 | 10.0/18.6 |
| Expansion, −30° C. to 100° C., | (E-5/° C.) | (E-5/° C.) |
| Flow/Crossflow | | |
| (ASTM E831) | | |

### Illustrative Examples 17-18

In Examples 17-18, 30 wt % of either PP3505G or PP8224, 15 wt % 0.25″ long polyester fibers obtained from Invista Corporation, and 45 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 4.

TABLE 4

| | | | Instrumented Impact |
|---|---|---|---|
| | | | at −30° C. |
| | | | Energy to maximum |
| | | Flexural Modulus, | load |
| | | Chord, psi | 25 lbs at 15 MPH |
| Example | Polypropylene, | (ISO 178) | (ASTM D3763), ft-lb |
| 17 | PP8224 | 433840 | 2 |
| 18 | PP3505 | 622195 | 2.9 |

The rubber toughened PP8114 matrix with PET fibers and talc displayed lower impact values than the PP3505 homopolymer. This result is surprising, because the rubber toughened matrix alone is far tougher than the low molecular weight PP3505 homopolymer alone at all temperatures under any conditions of impact. In both examples above, the materials displayed no splintering.

### Illustrative Examples 19-24

In Examples 19-24, 25-75 wt % PP3505G, 15 wt % 0.25″ long polyester fibers obtained from Invista Corporation, and 10-60 wt % V3837 talc were mixed in a Haake twin screw extruder at 175° C. The strand that exited the extruder was cut into 0.5″ lengths and injection molded using a Boy 50M ton injection molder at 205° C. into a mold held at 60° C. Injection pressures and nozzle pressures were maintained at 2300 psi. Samples were molded in accordance with the geometry of ASTM D3763 and tested for flexural modulus. The flexural modulus results are given in Table 5.

TABLE 5

| | | Flexural Modulus, |
|---|---|---|
| Example | Talc Composition, | Chord, psi (ISO 178) |
| 19 | 10% | 273024 |
| 20 | 20% | 413471 |
| 21 | 30% | 583963 |
| 22 | 40% | 715005 |
| 23 | 50% | 1024394 |
| 24 | 60% | 1117249 |

It is important to note that in Examples 19-24, the samples displayed no splintering in drop weight testing at an −29° C., 15 miles per hour at 25 pounds.

### Illustrative Examples 25-26

Two materials, one containing 10% ¼ inch polyester fibers, 35% PP3505 polypropylene and 60% V3837 talc (example 25), the other containing 10% ¼ inch polyester fibers, 25% PP3505 polypropylene homopolymer (example 26), 10% PO1020 modified polypropylene were molded in a Haake twin screw extruder at 175° C. They were injection molded into standard ASTM A370 ½ inch wide sheet type tensile specimens. The specimens were tested in tension, with a ratio of minimum to maximum load of 0.1, at flexural stresses of 70 and 80% of the maximum stress.

TABLE 6

| Percentage of | | |
|---|---|---|
| Maximum Stress to | Example 25, | Example 26, |
| Yield Point | Cycles to Failure | Cycles to Failure |
| 70 | 327 | 9848 |
| 80 | 30 | 63 |

The addition of the modified polypropylene is shown to increase the fatigue life of these materials.

### Illustrative Examples 27-29

A Leistritz 27 mm co-rotating twin screw extruder with a ratio of length to diameter of 40:1 was used in these experiments. The process configuration utilized was as depicted in FIG. 4. The screw configuration used is depicted in FIG. 6 and includes an arrangement of conveying and kneading elements. Talc, polypropylene and PET fiber were all fed into the extruder feed hopper located approximately two diameters from the beginning of the extruder screws (19 in the FIG. 6). The PET fiber was fed into the extruder hopper by continuously feeding from multiple spools a fiber tow of 3100 filaments with each filament having a denier of approximately 7.1. Each filament was 27 microns in diameter, with a specific gravity of 1.38.

The twin screw extruder ran at 603 rotations per minute. Using two gravimetric feeders, PP7805 polypropylene was fed into the extruder hopper at a rate of 20 pounds per hour, while CB 7 talc was fed into the extruder hopper at a rate of 15 pounds per hour. The PET fiber was fed into the extruder at 12 pounds per hour, which was dictated by the screw speed and tow thickness. The extruder temperature profile for the ten zones 144° C. for zones 1-3, 133° C. for zone 4, 154° C. for zone 5, 135° C. for zone 6, 123° C. for zones 7-9, and 134° C. for zone 10. The strand die diameter at the extruder exit was ¼ inch.

The extrudate was quenched in an 8 foot long water trough and pelletized to ½ inch length to form PET/PP composite pellets. The extrudate displayed uniform diameter and could easily be pulled through the quenching bath with no breaks in the water bath or during instrumented impact testing. The composition of the PET/PP composite pellets produced was 42.5 wt % PP, 25.5 wt % PET, and 32 wt % talc.

The PET/PP composite resin produced was injection molded and displayed the following properties:

TABLE 7

| | Example 27 | |
|---|---|---|
| Specific Gravity | 1.3 | |
| Tensile Modulus, Chord @ 23° C. | 541865 | psi |
| Tensile Modulus, Chord @ 85° C. | 257810 | psi |
| Flexural Modulus, Chord @ 23° C. | 505035 | psi |
| Flexural Modulus, Chord @ 85° C. | 228375 | psi |
| HDT @ 0.45 MPA | 116.1° | C. |
| HDT @ 1.80 MPA | 76.6° | C. |
| Instrumented impact @ 23° C. | 11.8 | J D** |
| Instrumented impact @ −30° C. | 12.9 | J D** |

**Ductile failure with radial cracks

In Example 28, the same materials, composition, and process set-up were utilized, except that extruder temperatures were increased to 175° C. for all extruder barrel zones. This material showed complete breaks in the instrumented impact test both at 23° C. and −30° C. Hence, at a barrel temperature profile of 175° C., the mechanical properties of the PET fiber were negatively impacted during extrusion compounding such that the PET/PP composite resin had poor instrumented impact test properties.

In Example 29, the fiber was fed into a hopper placed 14 diameters down the extruder (527 in the FIG. 6). In this case, the extrudate produced was irregular in diameter and broke an average once every minute as it was pulled through the quenching water bath. When the PET fiber tow is continuously fed downstream of the extruder hopper, the dispersion of the PET in the PP matrix was negatively impacted such that a uniform extrudate could not be produced, resulting in the irregular diameter and extrudate breaking.

### Illustrative Example 30

An extruder with the same size and screw design as Examples 27-29 was used. All zones of the extruder were initially heated to 180° C. PP 3505 dry mixed with Jetfine 700 C and PO 1020 was then fed at 50 pounds per hour using a gravimetric feeder into the extruder hopper located approximately two diameters from the beginning of the extruder screws. Polyester fiber with a denier of 7.1 and a thickness of 3100 filaments was fed through the same hopper. The screw speed of the extruder was then set to 596 revolutions per minute, resulting in a feed rate of 12.1 pounds of fiber per hour. After a uniform extrudate was attained, all temperature zones were lowered to 120° C., and the extrudate was pelletized after steady state temperatures were reached. The final composition of the blend was 48% PP 3505, 29.1% Jetfine 700 C, 8.6% PO 1020 and 14.3% polyester fiber.

The PP composite resin produced while all temperature zones of the extruder were set to 120° C. was injection molded and displayed the following properties:

TABLE 8

| | Example 30 | |
|---|---|---|
| Flexural Modulus, Chord @ 23° C. | 467,932 | psi |
| Instrumented impact @ 23° C. | 8.0 | J D** |
| Instrumented impact @ −30° C. | 10.4 | J D** |

**Ductile failure with radial cracks

All patents, test procedures, and other documents cited herein, including priority documents, are fully incorporated by reference to the extent such disclosure is not inconsistent with this disclosure and for all jurisdictions in which such incorporation is permitted.

While the illustrative forms of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the disclosure, including all features which would be treated as equivalents thereof by those skilled in the art to which the disclosure pertains.

When numerical lower limits and numerical upper limits are listed herein, ranges from any lower limit to any upper limit are contemplated.

What is claimed is:

1. A fiber reinforced composite front end module, said front end module comprising a radiator mounting frame molded from a composition comprising at least 30 wt % polypropylene based resin, from 10 to 60 wt % organic fiber, from 0 to 40 wt % inorganic filler, and from 0 to 0.1 wt % lubricant, based on the total weight of the composition, said radiator mounting frame having at least a first side and a second side.

2. The fiber reinforced composite front end module of claim 1, wherein said polypropylene based resin is chosen from polypropylene homopolymers, propylene-ethylene random copolymers, propylene-α-olefin random copolymers, propylene impact copolymers, and combinations thereof.

3. The fiber reinforced composite front end module of claim 2, wherein said polypropylene based resin is polypropylene homopolymer with a melt flow rate of from 20 to 1500 g/10 minutes.

4. The fiber reinforced composite front end module of claim 1, wherein said polypropylene based resin further comprises from 0.1 wt % to less than 10 wt % of a polypropylene based polymer modified with a grafting agent, wherein said grafting agent is chosen from acrylic acid, methacrylic acid, maleic acid, itaconic acid, fumaric acid or esters thereof, maleic anhydride, itaconic anhydride, and combinations thereof.

5. The fiber reinforced composite front end module of claim of claim 1, wherein said lubricant is chosen from silicon oil, silicon gum, fatty amide, paraffin oil, paraffin wax, and ester oil.

6. The fiber reinforced composite front end module of claim 1, wherein said organic fiber is chosen from polyalkylene terephthalates, polyalkylene naphthalates, polyamides, polyolefins, polyacrylonitrile, and combinations thereof.

7. The fiber reinforced composite front end module of claim 6, wherein said organic fiber is polyethylene terephthalate.

8. The fiber reinforced composite front end module of claim 1, wherein said inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

9. The fiber reinforced composite front end module of claim 8, wherein said inorganic filler is talc or wollastonite.

10. The fiber reinforced composite front end module of claim 1, wherein said front end module has a flexural modulus of at least 2.068 GPa and exhibits ductility during instrumented impact testing.

11. The fiber reinforced composite front end module of claim 1, wherein said front end module has a flexural modulus of at least 2.758 GPa, and exhibits ductility during instrumented impact testing.

12. The fiber reinforced composite front end module of claim 1, further comprising a radiator installed on either said first side or said second side of said radiator mounting frame.

13. The fiber reinforced composite front end module of claim 1, wherein said radiator mounting frame is formed as a single piece.

14. The fiber reinforced composite front end module of claim 13, wherein said radiator mounting frame is formed by injection molding.

15. The fiber reinforced composite front end module of claim 1, further comprising a pair of lateral end portions, each lateral end portion having a support structure for supporting a pair of head lamps.

16. The fiber reinforced composite front end module of claim 15, wherein each said lateral end portion includes a rear terminal section adapted to serve as an attaching portion for attaching to a vehicle body.

17. The fiber reinforced composite front end module of claim 1, further comprising a pair of bumper mounting brackets.

18. The fiber reinforced composite front end module of claim 1, further comprising a radiator fan installed on either said first side or said second side of said radiator mounting frame.

19. A process for producing a fiber reinforced composite front end module, the front end module having a radiator mounting frame having a first side and a second side, the process comprising the step of injection molding a composition to form the front end module, wherein the composition comprises at least 30 wt % polypropylene, from 10 to 60 wt % organic fiber, from 0 to 40 wt % inorganic filler, and from 0 to 0.1 wt % lubricant, based on the total weight of the composition.

20. The process of claim 19, wherein the front end module has a flexural modulus of at least 2.068 GPa and exhibits ductility during instrumented impact testing.

21. The process of claim 19, wherein the composition is formed by a step comprising extrusion compounding to form an extrudate.

22. The process of claim 21, wherein the organic fiber is cut prior to the extrusion compounding step.

23. The process of claim 21, wherein during the extrusion compounding step, the organic fiber is a continuous fiber and is fed directly from one or more spools into an extruder hopper.

24. The process of claim 21, further comprising the step of installing a radiator on either the first side or the second side of the radiator mounting frame.

25. The process of claim 19, further comprising the step of installing a pair of bumper mounting brackets.

26. The process of claim 19, wherein the radiator mounting frame is formed as a single piece.

27. The process of claim 26, wherein the radiator mounting frame is formed by injection molding.

28. The process of claim 19, wherein the fiber reinforced composite front end module includes a pair of lateral end portions, each lateral end portion having a support structure, for supporting a pair of head lamps.

29. The process of claim 28, wherein each lateral end portion includes a rear terminal section adapted to serve as an attaching portion for attaching to a vehicle body.

30. The process of claim 19, further comprising the step of installing a radiator fan on either said first side or said second side of said radiator mounting frame.

31. A process for making a fiber reinforced polypropylene composite front end module, comprising the following steps:
(a) feeding into a twin screw extruder hopper at least 25 wt % of a polypropylene based resin with a melt flow rate of from 20 to 1500 g/10 minutes;
(b) continuously feeding from 5 wt % to 40 wt % of an organic fiber;
(c) feeding into a twin screw extruder from 10 wt % to 60 wt % of an inorganic filler;
(d) extruding the polypropylene based resin, the organic fiber, and the inorganic filler through the twin screw extruder to form a fiber reinforced polypropylene composite melt;
(e) cooling the fiber reinforced polypropylene composite melt to form a solid fiber reinforced polypropylene composite; and
(f) injection molding the fiber reinforced polypropylene composite to form the front end module, the front end module having a radiator mounting frame having a first side and a second side.

32. The process of claim 31, wherein the fiber reinforced polypropylene composite front end module has a flexural modulus of at least 2.068 GPa and exhibits ductility during instrumented impact testing.

33. The process of claim 31, wherein the polypropylene based resin is chosen from polypropylene homopolymers, propylene-ethylene random copolymers, propylene-α-olefin random copolymers, propylene impact copolymers, and combinations thereof.

34. The process of claim 31, wherein the organic fiber is chosen from polyalkylene terephthalates, polyalkylene naphthalates, polyamides, polyolefins, polyacrylonitrile, and combinations thereof.

35. The process of claim 34, wherein the organic fiber is polyethylene terephthalate.

36. The process of claim 31, wherein the inorganic filler is chosen from talc, calcium carbonate, calcium hydroxide, barium sulfate, mica, calcium silicate, clay, kaolin, silica, alumina, wollastonite, magnesium carbonate, magnesium hydroxide, titanium oxide, zinc oxide, zinc sulfate, and combinations thereof.

37. The process of claim 36, wherein the inorganic filler is talc or wollastonite.

38. The process of claim 31, wherein said step of feeding the inorganic filler into the twin screw extruder further comprises feeding the inorganic filler into the twin screw extruder hopper via a gravimetric feed system or feeding the inorganic filler into the twin screw extruder at a downstream injection port via a gravimetric feed system.

39. The process of claim 31, wherein said step of cooling the fiber reinforced polypropylene composite melt to form a solid fiber reinforced polypropylene composite is by continuously passing strands of the fiber reinforced polypropylene composite melt through a cooled water bath.

40. The process of claim 31, further comprising the step of:
(g) installing a radiator on either the first side or the second side of the radiator mounting frame.

41. The process of claim 31, wherein said step of continuously feeding from 5 wt % to 40 wt % of an organic fiber includes unwinding from one or more spools the organic fiber and feeding the organic fiber into the twin screw extruder hopper.

42. The process of claim 31, wherein said step of continuously feeding from 5 wt % to 40 wt % of an organic fiber includes feeding 3.18 to 25.4 mm long polyester fibers into the twin screw extruder hopper.
